(19) United States
(12) Patent Application Publication
(10) Pub. No.: US 2013/0048558 A1
(43) Pub. Date: Feb. 28, 2013

(54) WATER TREATMENT METHOD AND ULTRAPURE WATER PRODUCING METHOD

(71) Applicants: Nobukazu Arai, Shinjuku-ku (JP); Nozomu Ikuno, Shinjuku-ku (JP)

(72) Inventors: Nobukazu Arai, Shinjuku-ku (JP); Nozomu Ikuno, Shinjuku-ku (JP)

(73) Assignee: KURITA WATER INDUSTRIES LTD., Tokyo (JP)

(21) Appl. No.: 13/582,475

(22) PCT Filed: Mar. 2, 2011
(86) PCT No.: PCT/JP2011/054810

§ 371 Date: Nov. 14, 2012

(30) Foreign Application Priority Data
Mar. 5, 2010 (JP) 2010-049232
Jul. 2, 2010 (JP) 2010-152324

(51) Int. Cl. C02F 9/04; C02F 9/14; C02F 1/70; C02F 1/76

(52) U.S. Cl. 210/615; 210/758

(57) ABSTRACT

A urea removal capability is increased in a water treatment method of introducing raw water containing organic substances, specially, urea to a reaction tank, adding water-soluble bromide salt and an oxidizing agent to perform an oxidation treatment on the urea, subsequently, performing a bio-treatment by a bio-treatment means. According to the water treatment method, TOC, particularly, urea in the raw water can be highly decomposed.

### TECHNICAL FIELD

The present invention relates to a water treatment method of raw water and a method of producing ultrapure water by using water treated by the water treatment method and particularly relates to a water treatment method, by which urea in raw water can be removed to a high degree, and an ultrapure water producing method using water treated by the water treatment method.

### BACKGROUND ART

Conventionally, an ultrapure water producing apparatus for producing ultrapure water from raw water, such as city water, ground water and industrial water, is basically configured by a pre-treatment apparatus, a primary pure water producing apparatus and a secondary pure water producing apparatus. Among them, the pre-treatment apparatus is configured by coagulating, floating and filtering apparatuses. The primary pure water producing apparatus is configured by two reverse osmosis membrane separation apparatuses and a mixed bed ion-exchange apparatus or by an ion-exchange pure water apparatus and a reverse osmosis membrane separation apparatus. The secondary pure water producing apparatus is configured by a low-pressure ultraviolet ray oxidizing apparatus, a mixed bed ion-exchange apparatus and an ultra-filtration membrane separation apparatus.

In an ultrapure water producing apparatus as such, demands for improving the purity have been increasing and, along therewith, removal of TOC components has been demanded. Among the TOC components in ultrapure water, particularly urea is hard to be removed, and the more the TOC components are reduced, the more a content of the TOC components is affected by removal of urea. Therefore, a sufficient reduction of TOC in ultrapure water by removing urea from water to be supplied to an ultrapure water producing apparatus has been described in the patent articles 1 and 2.

The patent article 1 describes incorporating a bio-treatment apparatus in a pre-treatment apparatus and decomposing urea in row water by the bio-treatment apparatus. Also, the patent article 2 describes adding sodium bromide and sodium hypochlorite to water under treatment (raw water) and decomposing urea in the raw water based on the reaction formula of (NH₂)₂CO+3NaBr+3NaClO→N₂+CO₂+2H₂O+6Na⁺+3Br⁻+3Cl⁻. Note that the patent article 2 describes in paragraphs [0030] and [0039] and in FIG. 1 that water obtained by a urea decomposing treatment of adding sodium bromide and sodium hypochlorite is brought to flow through an activated carbon column to decompose and remove residual sodium hypochlorite.

### PRIOR ART DOCUMENTS

### Patent Article

[Patent Article 1] Japanese Patent Publication (Kokai) No. H06-63592
[Patent Article 2] Japanese Patent Publication (Kokai) No. H09-94585

### DISCLOSURE OF THE INVENTION

### Problem to be Solved by the Invention

However, since bio-treatment as described in the patent article 1 has a poor load following capability, when a urea concentration in the raw water largely increases, it outpaces the urea removing treatment, the urea removal capability declines and a concentration of residual urea becomes high in the treated water, which is the problem.

Also, when a large amount of sodium bromide and sodium hypochlorite are added to raw water as in the water treatment method described in the patent document 2, there arises a problem that a load on the ion-exchange apparatus in the ultrapure water producing process becomes heavy for nothing. When a load on the ion-exchange apparatus becomes heavier, it is liable that an ion-exchange resin amount and regeneration frequency of the ion-exchange resin, etc. increase, the production cost of ultrapure water increases and the production efficiency of ultrapure water declines, etc.

The present invention was made in consideration of the above circumstances and has an object thereof to provide a water treatment method capable of highly discomposing TOC, particularly, urea in raw water. Another object of the present invention is to provide an ultrapure water producing method using the water treatment method.

To attain the above objects, firstly, the present invention provides a water treatment method comprising an oxidation treatment process for adding water-soluble bromide salt and an oxidizing agent to raw water containing organic substances, further comprising a bio-treatment process. (Invention 1).

According to the above invention (Invention 1), an oxidation treatment performed by adding water-soluble bromide salt and an oxidizing agent and a bio-treatment for decomposing organic substances by utilizing biotic working are combined to perform a treatment on raw water and, thereby, the urea removing function by the bio-treatment can be obtained while suppressing an adding amount of water-soluble bromide salt and an oxidizing agent. Consequently, it is possible to suppress a load on the ion-exchange apparatus in the ultrapure water production process and to enhance the urea removing capability.

In the above invention (Invention 1), preferably, readily biodegradable organic substances and/or an ammoniac nitrogen source are added to water supplied to the bio-treatment process. (Invention 2).

Removal of urea involves BOD assimilating bacteria or nitrobacteria. According to the above invention (Invention 2), while adding water-soluble bromide salt and an oxidizing agent to raw water for oxidative decomposition of a part of urea in raw water, a readily biodegradable organic substance is added to supplied water in a bio-treatment process so that BOD assimilating bacteria, which is heterotrophic bacteria using organic substances as a carbon source, and become highly active and increase. Also, when decomposing and assimilating organic substances, urea is taken in and decomposed as a nitrogen source (N source) to be required at a certain ratio (generally, BOD:N:P=100:5:1), consequently, the urea removal capability is considered to be increased.

Also, after adding water-soluble bromide salt and an oxidizing agent to raw water for the oxidative decomposition of a part of urea in the raw water, an ammoniac nitrogen source is added to the supplied water in the bio-treatment process, consequently, autotrophic bacteria using inorganic carbon (carbon dioxide, bicarbonic acid and carbonic acid) as a carbon source, that is, so-called nitrobacteria become highly active and increase. In the oxidation process of ammonia to nitrous acid and then to nitric acid, as a result of discomposing urea (NH₂)₂CO, it is possible to take in both of ammoniac nitrogen and inorganic carbon, therefore, the urea removal capability is considered to be increase.

In the above inventions (Inventions 1 and 2), the oxidation treatment process is performed before the bio-treatment process. (Invention 3). According to the invention (Invention 3), after roughly removing urea in raw water by the oxidation treatment process first, residual urea is removed in the bio-treatment process, consequently, urea and other persistent organic substances can be efficiently decomposed and removed.

In the inventions above (Inventions 1 to 3), preferably, the bio-treatment is performed by a bio-treatment means comprising organism-carrying carrier. (Invention 4). Also, in the invention above (Invention 4), preferably, the organism-carrying carrier is activated carbon. (Invention 5). According to the inventions (Inventions 4 and 5), since the bio-treatment means is a bio membrane method using organism-carrying carrier, an outflow of bacteria from the bio-treatment means can be suppressed more compared with the case with a fluidized bed, effects of the treatment become high and the effects can be maintained for a long time.

In the inventions above (Inventions 1 to 5), preferably, a reducing treatment is furthermore performed in a step after the bio-treatment. (Invention 6).

In the oxidation treatment process, a chlorine-based oxidizing agent (hypochlorous acid, etc.), etc. may be often used but they sometimes react with an ammoniac nitrogen source to form combined chlorine compounds. Combined chlorine has lower oxidation capability compared with free chlorine but may cause oxidation degradation of members of apparatuses in treatments in later steps, therefore, a reduction treatment is performed to make the combined chlorine compounds safe.

Also, secondly, the present invention provides an ultrapure water producing method, wherein treated water obtained by the water treatment method according to the above inventions (Inventions 1 to 6) is treated by a primary pure water apparatus and a secondary pure water apparatus to produce ultrapure water. (Invention 7).

According to the invention above (Invention 7), since urea is decomposed and removed sufficiently in the bio-treatment (water treatment) before the primary pure water apparatus and the secondary pure water apparatus, highly pure ultrapure water can be produced efficiently.

According to the water treatment method of the present invention, TOC, particularly, urea in raw water can be decomposed to a high degree.

### BRIEF DESCRIPTION OF DRAWINGS

FIG. 1 A system diagram showing a treatment apparatus for implementing a water treatment method according to an embodiment of the present invention.

FIG. 2 A system diagram showing an ultrapure water producing apparatus for implementing an ultrapure water producing method using the water treatment method according to the embodiment above.

FIG. 3 A graph showing urea removal effects in examples 2 to 4.

### MODE FOR CARRYING OUT THE INVENTION

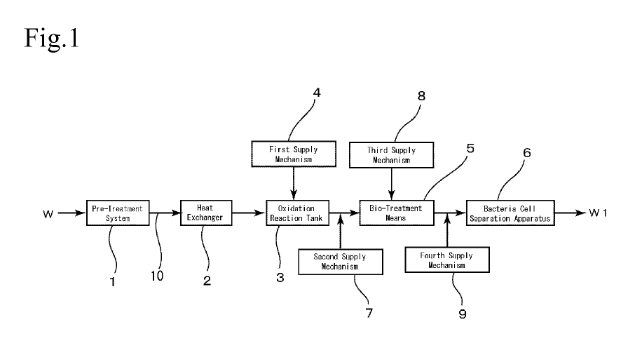

Below, an explanation will be made on embodiments of the present invention with reference to the attached drawings. FIG. 1 is a schematic view showing a treatment apparatus for implementing a water treatment method according to an embodiment of the present invention.

In FIG. 1, the reference number 1 is a pre-treatment system of raw water W to be supplied from a not shown raw water storage tank and the raw water W treated in the pre-treatment system 1 is adjusted to be a predetermined temperature by a heat exchanger 2 and supplied to an oxidation reaction tank 3 (hereinafter, simply referred to as “a reaction tank”). The reaction tank 3 is a single tank or has a multi-tank structure with two or more tanks and provided with a first supply mechanism 4 for supplying water-soluble bromide salt and an oxidizing agent. The reaction tank 3 is connected to a bio-treatment means 5, the bio-treatment means 5 is further connected to a bacteria cell separating apparatus 6 and, after being treated in these apparatuses, the result is supplied as treated water W1 to the primary pure water apparatus. In the treatment apparatuses as explained above, a second supply mechanism 7 for supplying a reducing agent is provided after the reaction tank 3. The bio-treatment means 5 is provided with a third supply mechanism 8 for supplying readily biodegradable organic substances or an ammoniac nitrogen source, so that it is possible to supply those to the water to be supplied to the bio-treatment means 5. Furthermore, after the bio-treatment means 5, a fourth supply mechanism 9 for supplying a reducing agent and a slime control agent is provided. The reference number 10 indicates pipes.

The treatment apparatus configured as above comprises a reaction tank 3 for implementing an oxidation treatment process of adding water-soluble bromide salt and an oxidizing agent to raw water containing organic substances and a bio-treatment means 5 for implementing a bio-treatment process for performing a bio-treatment on the raw water. In FIG. 1, an order of the oxidation treatment process and the bio-treatment process is not limited, but it is preferable that the treatment apparatus is configured to perform the oxidation treatment process before the bio-treatment process. This is because, when a urea concentration abruptly increases in the raw water in the oxidation treatment, an adding amount of bromide salt and an oxidizing agent can be increased to adjust the urea concentration in the oxidation treatment water to be about a normal level of water to be treated; while when the urea concentration in the raw water is low, the adding amount of bromide salt and oxidizing agent can be reduced to adjust the urea concentration level in the water before the bio-treatment to be a normal level. Therefore, load fluctuation can be suppressed in the oxidation treatment and the bio-treatment can be stabilized. Also, urea and other persistent organic substances can be efficiently decomposed and removed after roughly removing urea in the raw water.

In the treatment apparatus configured as explained above, the raw water W as a subject of the treatment contains organic substances, and ground water, river water, city water, other industrial water and collected water from semiconductor manufacturing processes, etc. may be used. Urea is contained in the organic substances in the raw water (treatment subject water) W, and a urea concentration in the raw water W is preferably 5 to 200 μg/L and particularly preferably 5 to 100 μm/L or so.

As the pre-treatment system 1, a general pre-treatment system in ultrapure water producing processes or a similar treatment thereto is preferable. Specifically, a treatment system including coagulation, pressure floatation and filtration, etc. may be used. Note that when murky components are less as in the case of using city water as the raw water W, the pre-treatment system 1 may be omitted.

As water-soluble bromide salt to be added from the first supply mechanism 4 to the reaction tank 3, for example, sodium bromide and other alkali bromides may be used. Also, as an oxidizing agent, sodium hypochlorite, chlorine dioxide and other chlorine-based oxidizing agents, etc. may be used.

Also, in a later step of the reaction tank 3, when an amount of residual oxidizing agent is large, it is preferable to supply a reducing agent from the second supply mechanism 7 to the pipe 10 if necessary. As the reducing agent, sulfur dioxide and other low oxides; thiosulfate, sulfite, bisulfite, nitrite and other low oxyacid salts; iron (II) salt and other low-valent metallic salt; formic acid, oxalic acid, L-ascorbic acid and other organic acids or salt thereof; and hydrazine, aldehyde, sugar, etc. may be used. Among them, nitrite, sulfite, iron (II) salt, sulfur dioxide, bisulfate, or oxalic acid, L-ascorbic acid or salts thereof may be preferably used.

Also, in the present embodiment, the bio-treatment means 5 is a means for implementing a treatment of decomposing and stabilizing contamination substances in sewage or other waste water by utilizing biotic working, which is separated to an aerobic treatment and an anaerobic treatment. Generally, organic substances are decomposed by oxygen respiration, nitric acid respiration and fermentation process, etc. and gasified or taken in by bacteria then removed as sludge in the bio-treatment. A removal treatment of nitride (a nitrification denitrification method) and phosphor (a biotic phosphor removing method) can be also performed. A means for performing a bio-treatment as such is generally called a biological reactor. The bio-treatment means 5 as such is not particularly limited but those provided with a fixed bed of organism-carrying carrier are preferable. Particularly, a downward flow type fixed bed is preferable for less bacteria outflow.

When the bio-treatment means 5 has a fixed bed, the fixed bed is preferably cleaned when necessary. Thereby, it is possible to prevent blocking of the fixed bed due to an increase of living organisms (bacteria), forming of mad balls and a decline of efficiency in urea decomposition and removal, etc. The cleaning method is not particularly limited but, for example, backwashing is preferable, that is, to let cleaning water flow in the reverse direction from the raw water flowing direction to fluidize carriers, discharge deposition substances to outside the system, crush mad balls and remove a part of living organisms, etc.

Also, a kind of carriers on the fixed bed is not particularly limited and activated carbon, anthracite, sand, zeolite, ion-exchange resin and plastic molded piece, etc. may be used, but carriers consuming a small amount of oxidizing agent are preferable for performing a bio-treatment in the presence of an oxidizing agent. However, in the case where there is a possibility that an oxidizing agent flows in to be at a high concentration to the bio-treatment means, carriers capable of decomposing oxidizing agents, such as activated carbon, are preferably used. When using activated carbon, etc. as such, it is possible to prevent bacteria from becoming deactivated or dying even when the concentration of oxidizing agents in raw water is high. Also, by using activated carbon, etc. as such, the limit of an oxidizing agent to flow into the bio-treatment means becomes higher, therefore, when using a reducing treatment to reduce the concentration of residual oxidizing agent in water after the oxidation treatment, it allows the reducing treatment to be lighter. For example, in the reducing treatment, an adding amount of a reducing agent can be reduced and control of the adding amount can be simplified. Accordingly, an increase of an ion load in the pure water producing process can be furthermore suppressed.

Also, as a readily biodegradable organic substances to be added to the supply water from the third supply mechanism 8 to the bio-treatment means 5, acetate, citric acid and other organic acids, sodium acetate and other organic acid salts, methanol, ethanol and other alcohols, acetone and other organic solvents and other general-purpose readily biodegradable type organic substances may be preferably used. Among them, organic substances having ionic character, such as sodium acetate, may be more preferably used from the viewpoint of being removable in a reverse osmosis membrane treatment or in an ion-exchange treatment by an ion-exchange resin performed as a treatment in a later step even if the added organic substances exceed the treatment capability and remain in biologically treated water.

Also, an ammoniac nitrogen source is not particularly limited and both of organic and inorganic ammoniac nitrogen sources may be preferably used. Among them, from the viewpoint of being easily removable in a later treatment even if the added ammoniac nitrogen source exceeds the treatment capability and remains in the biologically treated water, ammonium chloride, ammonium sulfate and other ammonium salts may be preferably used as an ammoniac nitrogen source having ionic character.

Also, in the water treatment method of the present embodiment, the purpose of adding readily biodegradable organic substances and/or an ammoniac nitrogen source to supply water in the bio-treatment process is to obtain a higher urea removal capability compared with that in the case of removing urea only by performing an oxidation treatment and bio-treatment. For this purpose, it is preferable to obtain and keep bacteria with an excellent urea removal capability. In terms of that, urea and urea derivatives may be added as an ammoniac nitrogen source. However, since urea and a part of urea derivatives do not have any ionic character, they are not expected to be removed in a later treatment. Therefore, when they are added in a large amount, it is highly possible that they cannot be removed in the bio-treatment and also in subsequent treatments and remain until the end. Therefore, when adding urea and urea derivatives, the adding concentration should be minimum and a method of complimenting a necessary amount of ammoniac nitrogen source with ammonium salt, etc. is preferable.

Adding of a reducing agent from the fourth supply mechanism 9 and/or a slime control agent to the pipe 10 in a later step of the bio-treatment means 5 and the bacteria cell separating apparatus 6 are not always necessary and any one or more of them may be provided arbitrarily depending on the situation. Specifically, in the case where an outflow of an oxidizing agent, etc. is observed and in the case of an outflow of bacteria is observed in the later steps of the bio-treatment means 5, if necessary, a reducing agent and/or a slime control agent can be added from the fourth supply mechanism 9 to the pipe 10. As the reducing agent and slime control agent, the same one supplied from the second supply mechanism 7 explained above may be used as the reducing agent.

As the slime control agent, a bactericidal agent which does not cause any adverse effect due to oxidation degradation, etc. in a later explained membrane treatment after the RO and ion-exchange treatment, etc. in the primary pure water apparatus (primary pure water system), etc. is preferable and, for example, a combined chlorine agent (combined chlorine agent having higher stability than chloramine) composed of a chlorine-based oxidizing agent and a sulfamic acid compound, and hydrogen peroxide, etc. may be used.

Furthermore, when an outflow of bacteria is observed, the bacteria cell separating apparatus 6 is preferably provided. The bacteria cell separating apparatus 6 is provided in accordance with need for the purpose of preventing troubles (clog in pipe, differential pressure rise and other slime problems, and biofouling of the RO membrane, etc.) in subsequent treatments in the primary pure water apparatus, etc. caused by bacteria (bacteria separated from organism carrier) contained in the treated water in the bio-treatment means 5. Specifically, membrane filtration (a membrane filtration treatment using a cartridge filter with a pore diameter of 0.1 μm or so) and coagulation filtration, etc. may be used.

Next, an explanation will be made on a water treatment method of the present embodiment using the apparatuses and additives, etc. as explained above.

First, raw water W is supplied to the pre-treatment system 1 and murky components are removed from the raw water W, consequently, a decline of efficiency in urea decomposition and removal due to the murky components in the subsequent bio-treatment means 5 is suppressed as well as suppressing an increase of a pressure loss in the bio-treatment means 5.

The heat exchanger 2 is used to heat the pre-treated raw water W when the water temperature is low, while cool it down when the temperature is high so as to adjust it to be a predetermined water temperature of preferably 20 to 40° C. or so. It is because the reaction in the reaction tank 3 is a physicochemical reaction of adding later explained water-soluble bromide salt and an oxidizing agent to roughly remove urea, and as the water temperature becomes higher, the reaction speed becomes higher and the decomposing efficiency increases. On the other hand, when the water temperature is too high, the reaction tank 3 and the connecting pipe 10, etc. have to have heat resistance, which may result in an increase of facility costs. While, when the water temperature of the raw water W is low, it may lead to a decline of the capability in roughly removing urea. Specifically, when the water temperature is 40° C. or lower, basically the biological activeness and removing speed increase as the water temperature becomes higher. However, when the water temperature exceeds 40° C., it is liable that the biological activeness and removing efficiency inversely decline in some cases. From these reasons, the water temperature under the treatment is preferably 20 to 40° C. Therefore, if the original temperature of the raw water W is within the range above, no adjustment has to be done.

The raw water W after temperature adjustment, if needed, as explained above is supplied to the reaction tank 3 and, by adding water-soluble bromide salt and an oxidizing agent from the first supply mechanism 4 to the reaction tank 3, oxidation decomposition (rough removal) of urea is performed. Here, an adding amount of water-soluble bromide salt is preferably 0.5 to 50 mg/L (in terms of bromine ion). When the adding amount of water-soluble bromide salt is less than 0.5 mg/L, oxidation decomposition of organic components is not sufficient, while when it exceeds 50 mg/L, the urea removal effect increases to a certain degree depending on the adding amount but not only may it adversely affect the subsequent bio-treatment means 5, but an increase of an ion load leads to an increase of a load on the primary pure water apparatus in the subsequent step, which is not favorable. A load on the primary pure water apparatus may include, for example, an increase of a running cost along with an increase of an osmotic pressure in the reverse osmosis membrane treatment, a scale trouble resulting from an increase of a salt concentration, and a decline of obtaining water resulting from an increase of a supply water ion load in the ion-exchange treatment (an increase of regeneration frequency), etc.

Also, the adding amount of an oxidizing agent varies depending on a kind of oxidizing agent to be used and, for example, when using chlorine-based oxidizing agent, the concentration of free effective chlorine may be 1 to 10 mg/L or so, particularly 1 to 5 mg/L or so, and specifically 2 mg/L or so. When the adding amount of a chlorine-based oxidizing agent is less than 1 mg/L, oxidation decomposition of organic components is not sufficient, while even if it exceeds 10 mg/L, the effect does not increase but residual oxidizing agent (including free chlorine) increases, therefore, an adding amount of reducing agent to be required for removing the free chlorine becomes too large.

A reducing treatment is performed by adding a reducing agent from the second supply mechanism 7 to the raw water W after subjected to the oxidation treatment in the reaction tank 3. The reducing treatment is not always necessary and may be performed only when residual oxidizing agent is large. Preferably, an adding amount of the reducing agent when performing the reducing treatment is determined depending on a concentration of the residual oxidizing agent explained above in accordance with need. For example, when reducing residual chlorine by using sodium sulfite, it may be added so that sulfite ion (SO₃²⁻) and hypochlorite ion (ClO⁻) become the present mols, and it may be added in an amount of 1.2 to 3.0 times considering safety factor. Because an oxidizing agent concentration in treated water varies, more preferably, the oxidizing agent concentration in the treated water is monitored and an adding amount of a reducing agent is controlled depending on the oxidizing agent concentration. Also, as a simple way, a method of measuring an oxidizing agent concentration regularly and setting an adding amount in accordance with the measured concentration may be also used. However, action limits of a free residual chlorine concentration and entire residual chlorine concentration explained above are action limits under the condition that granular activated carbon as organism carrier has residual chlorine removing capability. Therefore, when the organism carrier does not have any residual chlorine removing capability, it has to be controlled under the condition that residual chlorine is not detected (<0.02 mg/L·as CL₂).

As a method for detecting the oxidizing agent concentration mentioned above, an oxidation-reduction potential (ORP), etc. may be mentioned. As to residual chlorine, a residual chlorine meter (a polarographic method, etc.), etc. may be mentioned.

Subsequently, the raw water W is brought to pass through the bio-treatment means 5. The water passing speed to the bio-treatment means 5 is preferably SV 5 to 50 hr⁻¹ or so. A water temperature of the supply water to the bio-treatment means 5 may be, for example, 10 to 35° C., and pH is preferably neutral, for example, 4 to 8.

In the water treatment method of the present embodiment, readily biodegradable organic substances or an ammoniac nitrogen source is added to the raw water W by the third supply mechanism 8 in the bio-treatment means 5.

An adding amount of the readily biodegradable organic substances may be 0.1 to 2 mg/L (as C=in terms of carbon). When the adding amount of readily biodegradable organic substances is less than 0.1 mg/L, the capability of taking in and decomposing urea as a nitrogen source (N source) necessary for decomposing and assimilating the organic substances becomes insufficient, while when it exceeds 2 mg/L, not only that urea cannot be decomposed but a leakage amount from the bio-treatment means 5 becomes too large, which is unfavorable.

Also, when adding ammoniac nitrogen source, the adding amount may be 0.1 to 5 mg/L (in terms of NH₄⁺) Specifically, it should be added so that the concentration of ammonium ion in raw water W becomes within the range above. When the ammonium ion concentration in the raw water W is less than 0.1 mg/L (in terms of NH₄), it becomes difficult to keep a nitrobacteria group active, while when it exceeds 5 mg/L (in terms of NH₄), not only nitrobacteria do not become furthermore active but a leakage amount from the bio-treatment means 5 becomes too large, which is unfavorable.

By adding readily biodegradable organic substances or an ammoniac nitrogen source to the raw water W within the range above, the urea concentration in the treated water W1 in the bio-treatment means 5 after about 10 to 30 days can be kept to be 5 μg/L or lower, particularly about 3 μg/L or lower.

It is not always necessary to add the readily biodegradable organic substances or ammoniac nitrogen source above and, for example, a method of adding only in a start-up period at the time of organism carrier exchange or a method of repeating adding and not adding in every other certain period, etc. may be used. By not always adding ammoniac nitrogen source in this way, the effect of reducing cost of adding readily biodegradable organic substances or ammoniac nitrogen source can be obtained, as well.

Furthermore, in the present embodiment, when an outflow of an oxidizing agent or bacteria, etc. to the biologically treated water from the bio-treatment means 5 is observed, a reducing agent and/or slime control agent are added from the fourth supply mechanism 9.

Specifically, when free chlorine exists in supply water of the bio-treatment and ammonium salt, etc. is added as an ammoniac nitrogen source, free chlorine reacts with ammonium ion to generate combined chlorine (chloramine). Combined chlorine is hard to be removed even with activated carbon compared with free chlorine, consequently, combined chlorine leaks to biologically treated water. Combined chlorine is said to be a component having lower oxidation power compared with free chlorine, however, it is also known that free chlorine is generated again from combined chlorine due to equilibrium reaction. Therefore, there is a possibility of causing oxidation degradation in the primary pure water treatment system, etc. in a later step. From the reasons above, it is preferable to perform a reducing treatment as a post-treatment of the bio-treatment means 5 in accordance with need.

Also, a slime control agent may be added if necessary for the purpose of preventing troubles in subsequent steps (clog of pipes, differential pressure and other slime problems and biofauling of the RO film, etc.) caused by bacteria (bacteria separated from organism carrier) contained in the treated water of the bio-treatment means 5.

Also, if necessary, bacteria contained in the treated water of the bio-treatment means 5 are removed by the bacteria cell separating apparatus 6.

As to the adding of a reducing agent and/or slime control agent and the treatment by the bacteria cell separating apparatus 6, one or more of them may be performed depending on the water quality of the biologically treated water from the bio-treatment means 5 and if the water quality is good, they may be omitted.

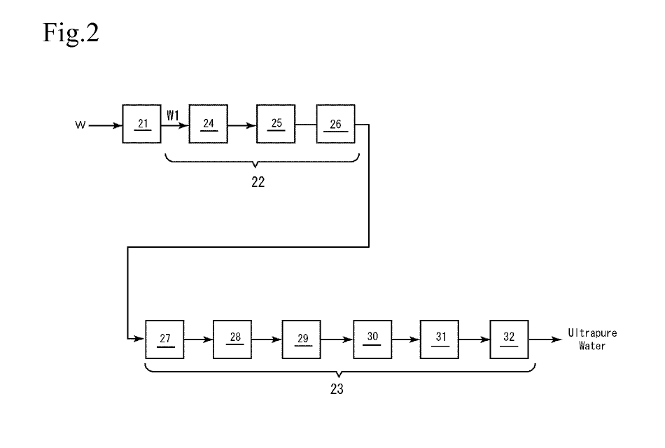

Next, an ultrapure water producing method using the water treatment method according to an embodiment of the present invention will be explained with reference to FIG. 2. In the ultrapure water producing method in the present embodiment, after treating raw water W in a water treatment apparatus 21 provided with the bio-treatment apparatus 5 explained above, the treated water W1 is furthermore treated by a primary pure water apparatus 22 and a subsystem (secondary pure water apparatus) 23.

The primary pure water apparatus 22 is configured by arranging a first reverse osmosis membrane (RO) separation apparatus 24, a mixed bed ion-exchange apparatus 25 and a second reverse osmosis membrane (RO) separation apparatus 26 in this order. Note that the apparatus configuration of the primary pure water apparatus 22 is not limited to the configuration as such and may be configured to be combined arbitrarily, for example, with a reverse osmosis membrane separation apparatus, ion-exchange treatment apparatus, electric deionizing exchange apparatus, UV oxidation treatment apparatus, etc.

The subsystem 23 is configured by arranging a sub tank 27, heat exchanger 28, low-pressure ultraviolet ray oxidation apparatus 29, membrane degasifier 30, mixed bed ion exchange apparatus 31 and ultrafiltration membrane apparatus (fine particle removal) 32 in this order. Note that the apparatus configuration of this subsystem 23 is not limited to the configuration as such and may be configured in combination, for example, with a UV oxidation treatment apparatus, ion-exchange treatment apparatus (non-regenerative) and UF membrane separation apparatus, etc.

An ultrapure water producing method by the ultrapure water producing system as such will be explained below. First, the treated water W1 treated in the water treatment apparatus 21 is subjected to a treatment in the primary pure water apparatus 22 to remove residual ion components, etc. in the treated water W1 by the first reverse osmosis membrane (RO) separation apparatus 24, mixed bed ion-exchange apparatus 25 and second reverse osmosis membrane (RO) separation apparatus 26.

Furthermore, in the subsystem 23, treated water of the primary pure water apparatus 22 passes through the sub tank 27 and the heat exchanger 28 and is introduced to the low-pressure ultraviolet ray oxidation apparatus 29, so that contained TOC components are ionized or decomposed. Furthermore, oxygen and carbon dioxide are removed in the membrane degasifier 30 and, successively, ionized organic substances are removed in the mixed bed ion-exchange apparatus 31. Treated water of the mixed bed ion-exchange apparatus 31 is furthermore subjected to a membrane separation treatment in the ultrafiltration membrane separation apparatus (fine particle removal) 32 and ultrapure water can be obtained.

According to the water treatment method of the present embodiment explained above, since raw water is treated by a combination of an oxidation treatment performed by adding water-soluble bromide salt and an oxidizing agent and a bio-treatment for decomposing organic substances by utilizing biotic working, it is possible to suppress a load on the ion-exchange apparatus in the ultrapure water producing process and increase the urea removal capability. Furthermore, an adding amount of chemicals can be reduced compared with the case of treating raw water by an oxidation treatment alone. Therefore, an increase of a treatment cost along with an increase of an ion load in the ultrapure water producing process and a decline of treatment efficiency, etc. can be suppressed. Also, due to the combination of different two kinds of removing mechanisms, the treatment is easily stabilized, and a decline of the treatment capability can be prevented even when a component ratio, etc. of components to be removed changes.

Furthermore, according to the water treatment method of the present embodiment, after adding water-soluble bromide salt and an oxidizing agent to raw water to roughly remove urea in the raw water, by adding readily biodegradable organic substances to supply water of the bio-treatment process, urea remaining as a nitrogen source (N source) required for decomposing and assimilating organic substances is taken in and decomposed, so that a capability of removing residual urea can be increased. Also, by adding ammoniac nitrogen source, autotrophic bacteria using inorganic carbon (carbon dioxide, bicarbonic acid and carbonic acid) as a carbon source, which are so-called nitrobacteria, become more active and increase and, by decomposing urea (NH₂)₂CO, both of the ammoniac nitride and inorganic carbon can be taken in, therefore, the capability of removing residual urea can be increased.

Also, according to the ultrapure water producing method as explained above, by sufficiently decomposing and removing urea in the bio-treatment means 5 and by removing other TOC components, metal ion, other inorganic and organic ion components in the primary pure water apparatus 22 and the subsystem 23 in the subsequent steps, highly-pure ultrapure water can be produced efficiently.

The present invention has been explained above with reference to the attached drawings, but the present invention is not limited to the above embodiments and may be implemented in variously modified ways. For example, readily biodegradable organic substances and an ammoniac nitrogen source to be added to the supply water of the bio-treatment means 5 may be used together.

### EXAMPLES

Below, the present invention will be explained further in detail with an example (example 1) of a water treatment method, wherein an oxidation treatment and bio-treatment are combined, and examples (examples 2 to 4), wherein the oxidation treatment and bio-treatment are combined and supply water of the bio-treatment is added with readily biodegradable organic substances or ammoniac nitrogen source.

### Example 1

### Oxidation Treatment and Bio-Treatment

Based on the flowcharts shown in FIG. 1 and FIG. 2, as raw water W (simulated raw water), what obtained by adding a proper amount of reagent urea (made by Kishida Chemical Co., Ltd.) to city water (water in Nogi-town) in accordance with need was used. In the present example, because city water was used as the raw water W, a treatment equivalent to the pre-treatment was already done in a water purifying plant, no pre-treatment was performed.

The oxidation treatment was performed by adding sodium bromide (NaBr, made by Kishida Chemical Co., Ltd.) in an amount of 10 mg/L and sodium hypochlorite (made by Kishida Chemical Co., Ltd.) in an amount of 3 mg/L in the reaction tank with a residence time of 30 minutes. Note that pH in the oxidation treatment was left to nature and no pH adjustment was made. The pH in the oxidation treatment was about 8.

Bio-treatment was performed by letting water flow through a packed tower, wherein 10 L of granular activated carbon (made by Kurita Water Industries Ltd. “Kuricoal WG160, 10/32 mesh”) as organism carrier was filled in a cylinder container. The water passing speed was SV=10/hr (water pass flow amount per hour/filled activated carbon amount).

As a biodegradation packed tower, reagent urea was acclimatized and those already exhibited urea decomposing capability were used. There was no reducing treatment performed between the oxidation treatment process and the bio-treatment process.

The simulated raw water was heated to 30° C. by the heat exchanger, subjected to the oxidation treatment, and oxidation treated water was supplied to the bio-treatment successively. When measuring urea concentrations of the oxidation treated water and biologically treated water, the urea concentration was 90 to 120 μg/L in the simulated raw water, 40 to 60 μg/L in the oxidation treated water and 2 to 3 μg/L in the biologically treated water.

The procedure of urea analysis in this example was as below. First, a residual chlorine concentration of water under test was measured by the DPD method and a reducing treatment with an equivalent amount of sodium bisulfite was performed. (After that, residual chlorine was measured by the DPD method to confirm that it was less than 0.02 mg/L.) Next, the water under test after the reducing treatment was brought to pass through the ion-exchange resin (made by Kurita Water Industries Ltd., “KR-UM1”) at SV 50/hr, subjected to a deionizing treatment, concentrated to 10 to 100 times by a rotary evaporator, then, a urea concentration was determined by a diacetylmonoxime method.

In the example 1, electric conductivity of oxidation treated water was 18 to 22 mS/m, and that of biologically treated water was 18 to 22 mS/m.

### Comparative Example 1

### Oxidation Treatment Only

An oxidation treatment was performed by adding sodium bromide (made by Kishida Chemical Co. Ltd., NaBr) in an amount of 20 mg/L and sodium hypochlorite (made by Kishida Chemical Co. Ltd.) in an amount of 6 mg/L (as an effective chlorine concentration) in the reaction tank with a residence time of 30 minutes.

Other than not performing the bio-treatment and adding sodium bisulfite (made by Kishida Chemical Co. Ltd.) in an amount of 9 mg/L for a reducing treatment of oxidation treated water with a residual chlorine concentration of 5.5 to 6.0 mg/L as Cl₂, same treatments as in the example 1 were performed.

A residual chlorine concentration of oxidation treated water after the reducing treatment was less than 0.02 mg/L as Cl₂ and it was considered that there was no outflow of residual chlorine.

In the comparative example 1, a urea concentration of oxidation treated water was 30 to 40 μg/L. The electric conductivity was about 30 mS/m.

### Comparative Example 2

### Oxidation Treatment Only

Other than changing the residence time to 60 minutes, same treatments as those in the comparative example 1 were performed.

In the comparative example 2, a urea concentration of oxidation treated water was 2 to 10 μg/L and electric conductivity was about 30 mS/m.

From the above results, a urea concentration of the treated water in example 1, wherein the oxidation treatment and bio-treatment were combined, was significantly lower than those of the treated water in the comparative example 1 and the comparative example 2, wherein only the oxidation treatment was performed. Also, electric conductivity of the treated water in the example 1 became about ⅔ of that of treated water in the comparative examples 1 and 2. Accordingly, in the example 1, it was confirmed that an ion load in later steps was suppressed and urea in the raw water W was able to be removed to a high degree.

Next, the present invention will be explained further in detail with examples (examples 2 to 4), wherein the oxidation treatment and bio-treatment are combined and biologically treated water was added with readily biodegradable organic substances or an ammoniac nitrogen source.

### Example 2

The flowcharts shown in FIG. 1 and FIG. 2 were used and, as raw water W, what obtained by adding a proper amount of reagent urea (made by Kishida Chemical Co., Ltd.) to city water (water in Nogi-town: average urea concentration of 10 μg/L, average TOC concentration of 500 μg/L) in accordance with need was used.

As a bio-treatment means 12, one having as a fixed bed a cylinder container filled with organism carrier, 2 L of granular activated carbon (made by Kurita Water Industries Ltd. “Kuricoal WG160, 10/32 mesh”), was used. As the granular activated carbon of the bio-treatment means 12, reagent urea was acclimatized and those already exhibited urea decomposing capability were extracted in an amount of 0.6 L from a packed tower and mixed with 1.4 L of new carbon for use.

First, city water (not added with reagent urea) was added with urea in an amount of about 100 mg/L to prepare raw water W (simulated raw water). Since a water temperature of the raw water W was 13 to 17° C., it was heated to 20 to 22° C. by the heat exchanger 2. A urea concentration of the city water itself in the test period was 7 to 25 μg/L, an ammoniac nitride concentration was 0.1 mg/L or lower and TOC was 0.4 to 0.7 mg/L. Note that, in the present example, since city water was used as raw water W and a treatment equivalent to the pre-treatment was already done in a water purifying plant, no pre-treatment was performed.

This raw water W was added with sodium bromide (made by Kishida Chemical Co., Ltd., NaBr) in an amount of 2 mg/L and sodium hypochlorite (made by Kishida Chemical Co., Ltd.) in an amount of 2 mg/L (as an effective chlorine concentration) and supplied to a reaction tank 3, wherein two tanks are arranged in series, with a residence time of 15 minutes to perform an oxidation treatment. During this time, sodium bromide and sodium hypochlorite were added to the first reaction tank and pH in the first reaction tank was referred to and adjusted to be 5.5 to 6.0 by adding sulfuric acid.

A residual chlorine concentration of the treated water after the oxidation decomposition, as well as a free residual chlorine concentration and total residual chlorine concentration, were about 1 mg/L·as Cl₂, so that a reducing treatment was not performed.

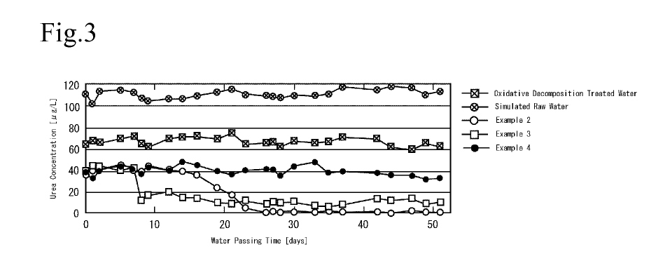

Subsequently, the raw water W was brought to pass downwardly through the bio-treatment means 5. The water passing speed SV was 20/hr (water pass flow amount per hour/filled activated carbon amount). As to the biologically treated water after passing through, a urea concentration was analyzed for 50 days. The results are shown in FIG. 3 together with the urea concentration of the raw water W and urea concentration after the oxidation treatment. Note that, in the water passing treatment as above, backwashing for 10 minutes was performed once a day. The backwashing was performed with the biologically treated water in an upward flow from a lower part to an upper part of the cylinder container at LV=25 m/hr (water pass flow amount per hour/cylinder container section area).

A procedure of the urea concentration analysis was as below. First, a total residual chlorine concentration of the water under test was measured by the DPD method and a reducing treatment with an equivalent amount of sodium bisulfite (After that, the entire residual chlorine was measured by the DPD method and confirmed to be less than 0.02 mg/L.) was performed. Next, the water under test subjected to the reducing treatment was brought to pass through an ion-exchange resin (“KR-UM1” made by Kurita Water Industries Ltd.) at SV 50/hr, subjected to a deionizing treatment and concentrated to 10 to 100 times by a rotary evaporator, then, a urea concentration was determined by a diacetylmonoxime method.

Note that no pH adjustment was made during the water passing test period. The pH during the test period was 6.0 to 6.5. Also, dissolved oxygen (DO) in the raw water W during the test period was 6 mg/L or more and a dissolved oxygen concentration in the treated water W1 of the bio-treatment means 5 was 2 mg/L or higher, therefore, it was considered that dissolved oxygen was not in short and no adjustment was made on the dissolved oxygen concentration. Also, after the bio-treatment means 5, a reducing agent or a slime control agent was not added.

As is clear from FIG. 3, from the start of water passing without adding ammonium chloride up to the seventh day of the water passing, the urea concentration of the supply water was 100 to 120 μm/L, a urea concentration of the oxidation treated water was 60 to 75 μm/L and a urea concentration of the treated water was about 40 μm/L.

Next, on the seventh day from the start of water passing, ammonium chloride (made by Kishida Chemical Co., Ltd.) as an ammoniac nitrogen source was started to be added to the raw water W on a steady basis, so that the ammonium ion concentration became about 0.5 mg/L (in terms of NH₄⁺).

As a result, from around the 15th day from the start of passing water (8 days after starting to add ammonium chloride), a gradual decline of urea was observed, and on the 25th day after starting the water passing (about 18 days after starting to add ammonium chloride), the urea concentration of the biologically treated water became stable at 3 μg/L or lower.

### Example 3

In the example 2, other than adding sodium acetate instead of ammonium chloride as an ammoniac nitrogen source on a steady basis to attain a TOC concentration of about 0.5 mg/L (in terms of carbon), a water passing test was performed in the same way as in the example 2 and a urea concentration was analyzed for 50 days, the results are shown together in FIG. 3.

As is clear from FIG. 3, from the next day of start adding sodium acetate (8 days from the start of water passing), a gradual decline of urea was observed and, after that, a urea concentration of the biologically treated water became stable at 7 to 20 μg/L.

### Example 4

In the example 2, other than not adding ammonium chloride, the water passing test was performed in the same way and a urea concentration was analyzed for 50 days. The results are shown together in Table 3.

As is clear from FIG. 3, in the examples 2 to 4, wherein the oxidation treatment and bio-treatment were combined, it was confirmed that a high urea removal capability was obtained compared with those in the cases only with the oxidation treatment. Furthermore, in the example 2 and in example 3, wherein the supply water of the bio-treatment process was added with readily biodegradable organic substances and/or an ammoniac nitrogen source, furthermore higher urea removal capability can be obtained compared with that in the example 4, wherein the organic substances, etc. were not added.

### EXPLANATION OF REFERENCE NUMBERS

3 . . . reaction tank (oxidation reaction tank)
4 . . . first supply mechanism (water-soluble bromide salt, oxidizing agent)
5 . . . bio-treatment means
8 . . . third supply mechanism (readily biodegradable organic substances, ammoniac nitrogen source)
9 . . . fourth supply mechanism (reducing treatment: reducing agent, slime control agent)
22 . . . primary pure water apparatus
23 . . . subsystem (secondary pure water apparatus)
W . . . raw water
W1 . . . treated water

1. A water treatment method comprising an oxidation treatment process for adding water-soluble bromide salt and an oxidizing agent to raw water containing organic substances, further comprising a bio-treatment process.

2. The water treatment method according to claim 1, wherein readily biodegradable organic substances and/or ammoniac nitrogen source are added to water supplied to the bio-treatment process.

3. The water treatment method according to claim 1, wherein the oxidation treatment process is performed before the bio-treatment process.

4. The water treatment method according to claim 1, wherein the bio-treatment is performed by a bio-treatment means comprising organism-carrying carrier.

5. The water treatment method according to claim 4, wherein the organism-carrying carrier is activated carbon.

6. The water treatment method according to claim 1, wherein a reducing treatment is furthermore performed in a step after the bio-treatment.

7. An ultrapure water producing method, wherein treated water obtained by the water treatment method according to claim 1 is treated by a primary pure water apparatus and a secondary pure water apparatus to produce ultrapure water.

8. The water treatment method according to claim 2, wherein the oxidation treatment process is performed before the bio-treatment process.

9. The water treatment method according to claim 2, wherein the bio-treatment is performed by a bio-treatment means comprising organism-carrying carrier.

10. The water treatment method according to claim 3, wherein the bio-treatment is performed by a bio-treatment means comprising organism-carrying carrier.

11. The water treatment method according to claim 8, wherein the bio-treatment is performed by a bio-treatment means comprising organism-carrying carrier.

12. The water treatment method according to claim 2, wherein a reducing treatment is furthermore performed in a step after the bio-treatment.

13. The water treatment method according to claim 3, wherein a reducing treatment is furthermore performed in a step after the bio-treatment.

14. The water treatment method according to claim 4, wherein a reducing treatment is furthermore performed in a step after the bio-treatment.

15. The water treatment method according to claim 5, wherein a reducing treatment is furthermore performed in a step after the bio-treatment.

16. An ultrapure water producing method, wherein treated water obtained by the water treatment method according to claim 2 is treated by a primary pure water apparatus and a secondary pure water apparatus to produce ultrapure water.

17. An ultrapure water producing method, wherein treated water obtained by the water treatment method according to claim 3 is treated by a primary pure water apparatus and a secondary pure water apparatus to produce ultrapure water.

18. An ultrapure water producing method, wherein treated water obtained by the water treatment method according to claim 4 is treated by a primary pure water apparatus and a secondary pure water apparatus to produce ultrapure water.

19. An ultrapure water producing method, wherein treated water obtained by the water treatment method according to claim 5 is treated by a primary pure water apparatus and a secondary pure water apparatus to produce ultrapure water.

20. An ultrapure water producing method, wherein treated water obtained by the water treatment method according to claim 6 is treated by a primary pure water apparatus and a secondary pure water apparatus to produce ultrapure water.
